(19) United States
(12) Patent Application Publication
(10) Pub. No.: US 2017/0169363 A1
(43) Pub. Date: Jun. 15, 2017

(54) Integrated System of Search, Commerce and Analytics Engines Supported by Beacons, Mobile Consumer and Merchant Applications Which Discover, Connect to, Report on, Communicate and Transact with Places, People and Objects Based on Their Proximal, Ephemeral and Analytical Attributes on a Symmetric Basis

(71) Applicant: Max2 Inc., New York, NY (US)

(72) Inventors: Allen Salmasi, New York, NY (US); Michael Salmasi, New York, NY (US); Daniel Moreno, New York, NY (US); Rohan Nagrani, New York, NY (US); Pranav Bhalla, New York, NY (US); Jay Chung, New York, NY (US); Shubhanshu Yadav, New York, NY (US); Atesh Yurdakul, New York, NY (US)

(73) Assignee: Max2 Inc., New York, NY (US)

(21) Appl. No.: 15/376,126

(22) Filed: Dec. 12, 2016

Related U.S. Application Data
(60) Provisional application No. 62/265,528, filed on Dec. 10, 2015.

(51) Int. Cl. G06Q 10/02; G06Q 30/02; G06Q 20/32; H04W 4/20

(52) U.S. Cl. CPC G06Q 10/02; H04W 4/206; G06Q 30/0267; G06Q 20/322; G06Q 50/01

(57) ABSTRACT

Method and Apparatus for providing an integrated platform for discovery, messaging, social networking and electronic commerce, including payment services, which enables Multi-Modal Proximity services. When associated with mobile devices the platform enables Real time, Proximal Search, Discovery, Communications, and Commerce including various forms of Payments. Mobile applications use the service delivery platform to interact, using multimodal communications (Human to Human (H2H), Human to Machine (H2M), M2M, M2H), with other applications, places, people or objects.

### CROSS REFERENCE TO RELATED APPLICATIONS

This application claims the benefit of the filing date of U.S. provisional patent application No. 62/265,528 entitled “Integrated System of Search, Commerce and Analytics Engines Supported by Beacons, Mobile Consumer and Merchant Applications Which Discover, Connect to, Report on, Communicate and Transact with Places, People and Objects Based on Their Proximal, Ephemeral and Analytical Attributes on a Symmetric Basis”, which was filed on Dec. 10, 2015, by the same patentee of this application and which shares the same inventor as this application. That provisional application is hereby incorporated by reference as if fully set forth herein.

### FIELD OF THE TECHNOLOGY

The technology of this application relates generally to mobile devices and applications thereon and more particularly but not exclusively to a mobile application which provides an integrated platform of discovery, messaging, social networking and electronic commerce, including card present and card-not-present (card on file) payments (“Payments”).

### BACKGROUND OF THE TECHNOLOGY

Mobile phones and other mobile computerized devices have become an integral part of society. Many software applications running on these mobile devices are capable of providing customized user experiences for both merchants and consumers. They are also useful for social interaction. Many social networking applications exist for connecting people and many commerce (merchant and/or consumer) applications exist which attempt to make shopping more efficient and enjoyable for consumers. Additionally, use of mobile payment technology has been growing in popularity.

The cryptographic technology that underlies Bitcoin, called the “blockchain” is a distributed ledger. It is essentially a public database for the Internet. It contains the payment history of every Bitcoin in circulation and provides proof of who owns what at any given juncture. This distributed ledger is replicated on many computers—“Bitcoin nodes”—around the world and is publicly available. Notably, it is also trustworthy and secure due to the mixture of mathematical subtlety and computational brute force built into its “consensus mechanism”—the process by which the nodes agree on how to update the blockchain in light of Bitcoin transfers

Currently blockchain is designed as an “open platform” and some of the data in the blockchain relates to Bitcoins. However, other type of data may be tracked using blockchain. Conventional blockchain-based offerings may be divided into different categories. One category takes advantage of the fact that any type of asset can be transferred using the blockchain. For example, the company Colu has developed a mechanism to “dye” very small Bitcoin transactions (called “Bitcoin dust”) by adding extra data to them so that they can represent bonds, stock shares or units of precious metals. Another category includes using the blockchain for authentication purposes. Protecting land titles is an example of the second category.

Bitcoin transactions can be combined with snippets of additional information which then also become embedded in the ledger. It can thus be a registry of anything worth tracking. Everledger uses blockchain to protect luxury goods (e.g. it adds data to the blockchain about a gemstone's distinguishing attributes, providing unchallengeable proof of its identity should it be stolen). Onename stores personal information in a way that is meant to eliminate the need for passwords; CoinSpark acts as a notary, etc. It should be noted however that using blockchain for certain of these applications requires a certain amount of trust that the intermediary will store the data accurately.

Another distributed ledger, which appears to deal with more data than Bitcoin's is provided by Ethereum. It includes a programming language that allows users to write sophisticated smart contracts. This enables users to create invoices that pay themselves when a shipment arrives or share certificates which automatically send their owners dividends if profits reach a certain level.

### BRIEF SUMMARY OF THE TECHNOLOGY

Many advantages will be determined and are attained by one or more embodiments of the technology, which in a broad sense provides a system of social networking applications with methods and apparatus for creating interactive profiles. By employing beacons and mobile devices, consumers, objects (e.g., a vending machine) and merchants may interact based on their proximity to one another. A consumer using the system may determine the current status of a merchant commonly referred to as ephemeral data (e.g., crowd levels, queue length, current offers, ambiance, noise levels, etc.) and optionally broadcast the information to other users. The consumer using the system may determine this information in various ways—it may be reported by other users (i.e., crowdsourced) and posted to the platform for everyone's benefit, the consumer may ask for and receive an answer from the merchant, the establishment may post the information on its profile page, the information could be obtained and posted from other available sources such as social media (e.g. people might be posting reviews which may be posted and accessed in real time), and/or it may be determined from predictive analytics based on current and historical trends. Additionally, merchants may push real time notifications to consumers located within a certain distance from one or more beacons. The information may include, but is not necessarily limited to specials, limited time sales, inventory (e.g. we just ran out of tonight's cheesecake special, we received an unexpected order of truffles), etc. Additionally, the suite may include a mapping function which enables a user to select a random or preset bounded area using free-form drawing features and/or preset drawing features to search for points of interest within that area. The user draws a bounded shape on the map and the application provides points of interest within that bounded area. Additionally, in the event that the drawn boundary is not closed, the application will finish closing off the area. Points of interest within that bounded area can be filtered through their ephemeral and non-ephemeral data. Users can create meetings/plans by selecting times and places within the bounded area and having invited meeting attendees vote on the most popular times and/or venues displayed within that bounded area. Meeting attendees can also suggest other locales, venues, date and/or times. Finally, the suite provides local lists/collections (e.g. best eats, best deals on merchandise, best desserts, certain types of restaurants such as organic foods, personal shopping favorites etc.).

One or more embodiments of the technology provide for a system for discovery, messaging, integrated social networking and e-commerce, including Payments. The system includes one or more backend servers (“backend”) and at least one mobile device. The mobile device is in selective electrical communication with the backend server. The mobile device includes a Graphical User Interface (“GUI”) associated with the mobile device. The GUI displays and may act as an input device which provides for venue, events or people discovery (e.g., shops, restaurants, bars, hair salons, doctors, hospitals, theaters, bowling alleys, concert at the park, local festival, plumbers nearby, etc.), interactive short-form data communications (e.g., messaging), social networking and e-commerce features to a user of the mobile device. The system also includes one or more beacon transmitting signals for receipt by the mobile device, such that the discovery, messaging, social networking or e-commerce features are bounded by an area proximal to the beacon in certain cases. The mobile devices themselves can act as a beacon based on various standards already published (e.g., WiFi Aware™, LTE-based Proximity-based Services or “ProSe” as defined in Release 12 of 3GPP standards) or being developed based on various wireless standards.

One or more embodiments of the technology provides a method for providing a localized discovery, messaging, integrated social networking and e-commerce, including Payments, platform on a mobile device through an application running on the mobile device. This feature may be enhanced when the mobile device detects a signal from at least one beacon. The method includes the mobile device detecting the signal from the beacon and receiving as input a selection of a particular feature related to the signal from the beacon. The mobile device sends a query to the backend for information related to the feature and displays the response to the query on a display associated with the mobile device.

One or more embodiments of the platform technology provides a method for providing a localized discovery, messaging, integrated social networking and e-commerce, including Payments, on a mobile device through an application running on the mobile device, which may be enhanced when the mobile device detects a signal from one or more beacons in its proximity. The method includes the beacon transmitting a signal for receipt by a mobile device while the mobile device is located proximal to the beacon. Once a signal from a beacon broadcasting a certain message is discovered by the mobile device, the backend receives a request from the mobile device for information about the venue associated with the beacon. The backend, in response to receiving the query from the mobile device, communicates the relevant or pre-selected information to the mobile device. The ephemeral information about a venue is crowdsourced and updated in real time or substantially real time to provide current information about the venue. Discovery of an offer or promotion may also be the result of a merchant publishing such an offer or promotion through the merchant application and the consumer receiving that promotion based on its preference settings such as having the merchant pre-selected as a favorite merchant. These methods of discovery are collectively referred to as “Discovery Services”.

The technology will next be described in connection with certain illustrated embodiments and practices. However, it will be clear to those skilled in the art that various modifications, additions and subtractions can be made without departing from the spirit or scope of the claims.

### BRIEF DESCRIPTION OF THE DRAWINGS

For a better understanding of the technology, reference is made to the following description, taken in conjunction with the accompanying drawings, in which like reference characters refer to like parts throughout, and in which:

FIGS. 1a-c illustrate a graphical user interface which provides a user with options for selecting their interests;

FIGS. 2a-b illustrate a graphical user interface which provides a general dashboard for selecting one or more of a suite of services;

FIGS. 3a-d illustrate a graphical user interface which provides a mapping function;

FIGS. 4a-b illustrate a graphical user interface which provides a Now or current events feature;

FIGS. 5a-b illustrate a graphical user interface which provides a list of filters to apply to a venue;

FIGS. 6a-k illustrate a graphical user interface which provides a venue view;

FIGS. 7a-s illustrate a graphical user interface which provides a meeting planner;

FIGS. 8a-e illustrate a graphical user interface which provides collections of common topics;

FIGS. 9a-c illustrate a graphical user interface which provides activity status at various locations;

FIG. 10 provides a block diagram of a system in accordance with one or more embodiments of the technology; and

FIG. 11 provides a block diagram illustrating various components which will be included in the various elements of the system of FIG. 10.

The technology will next be described in connection with certain illustrated embodiments and practices. However, it will be clear to those skilled in the art that various modifications, additions, and subtractions can be made without departing from the spirit or scope of the claims.

### DETAILED DESCRIPTION OF THE TECHNOLOGY

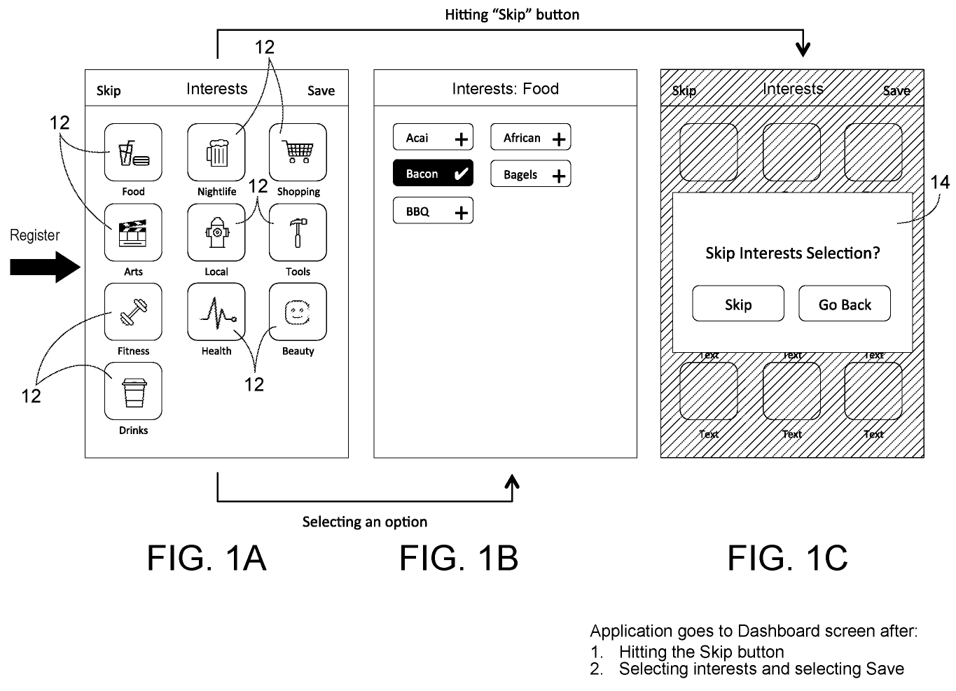

Referring to the figures in detail wherein like reference numerals identify like elements throughout the various figures, there is illustrated in FIGS. 1-11 an integrated discovery, messaging, social networking, e-commerce and search platform. The following description will focus on use of an iBeacon® transmitter, but those skilled in the art will recognize that other transmitters (e.g. Eddystone®, AltBeacon®, WiFi Aware™, ultrasound, a combination of these techniques, etc.) can be employed without departing from a scope of the technology. The description shall also focus on mobile phones, but those skilled in the art will recognize that the technology is equally applicable to other mobile devices (e.g. smartphones, Personal Digital Assistants (“PDAs”), laptop computers, tablets, e-readers, portable game units, smart watches, etc. that have the ability to run apps and transmit and receive data).

Discussion of an embodiment, one or more embodiments, an aspect, one or more aspects, a feature, one or more features, or a configuration or one or more configurations is intended be inclusive of both the singular and the plural depending upon which provides the broadest scope without running afoul of the existing art and any such statement is in no way intended to be limiting in nature. Technology described in relation to one or more of these terms is not necessarily limited to use in that particular embodiment, aspect, feature or configuration and may be employed with other embodiments, aspects, features and/or configurations where appropriate.

The Platform creates an ecosystem which supports various services. As with most mobile software applications (“apps”), the user signs up for the app by entering name, password and any other conventional information that is usually entered for signing up for an app. Those skilled in the art will recognize that the information collected is a design choice. Once the user signs up for the app, the user is presented with a login screen 10 FIG. 1A. Once again those skilled in the art will recognize that the information collected for this purpose is a design choice also whether or not to require a login is a design choice. The first time a user logs into the app, the user is presented with the login screen 10 illustrated in FIG. 1a which allows the user to select interests such as food, fitness, shopping etc. As illustrated in FIG. 1b different levels of granularity may be provided for these areas of interests. As illustrated in FIG. 1c, the user may be provided with the option 14 to skip one or more levels of this feature.

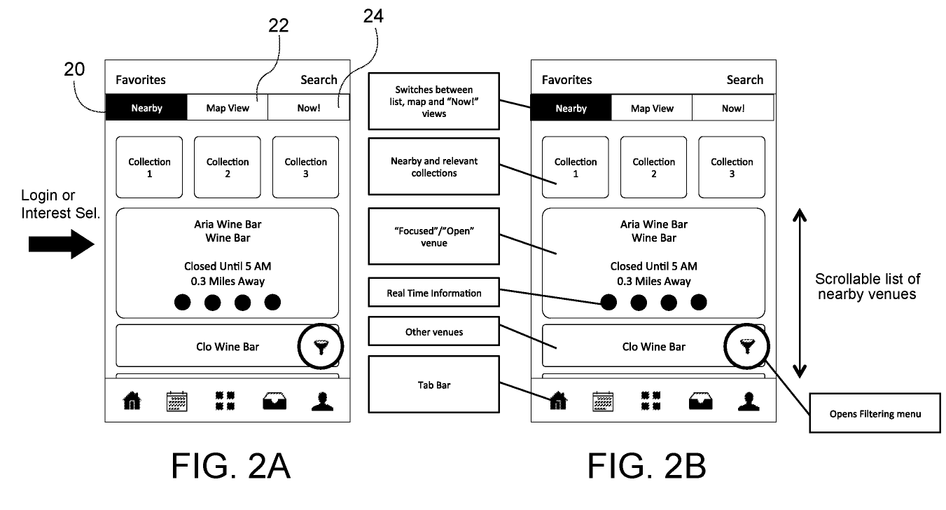

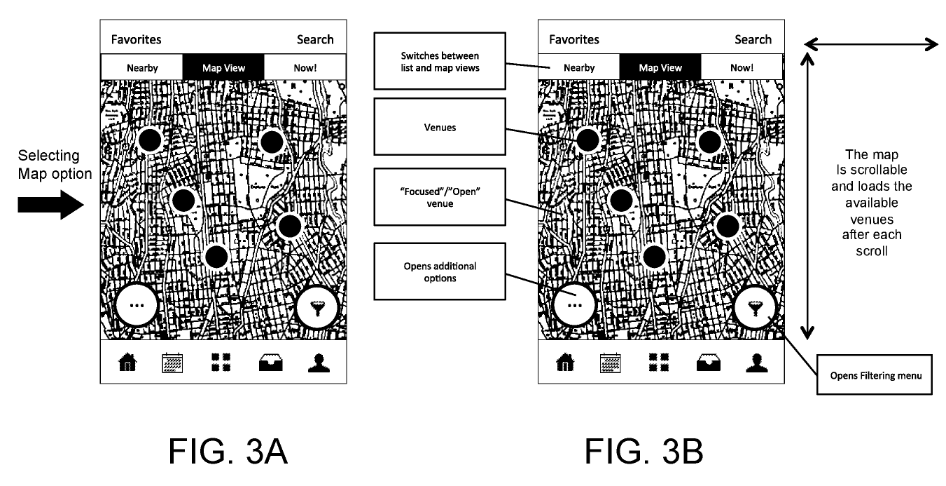

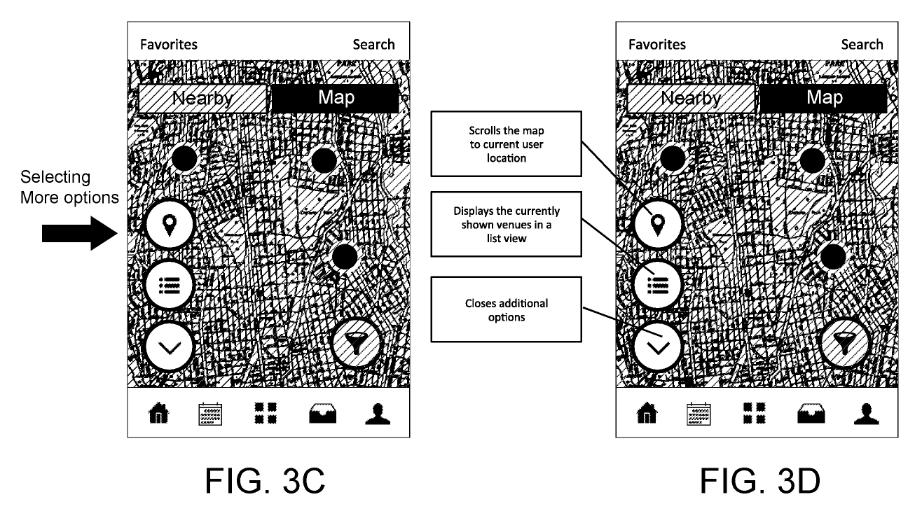

FIGS. 2a-b illustrate a GUI's main screen (dashboard) which provides the user with top level options 20-24. From this screen the user can select one of the various available features. The default view is “Nearby” 20 which may illustrate a single venue, multiple venues or groups depending on the number of times the smartphone screen is refreshed (although this is merely a design choice), which provides information from the various features related to venues, points or objects of interest, events and happenings in close proximity to the mobile device tied to user's preferences for certain views (i.e., types or categories of information displayed), items of interest to the user or as filtered based on user settings. If the user selects Map View 22 (FIGS. 3a-d) the display changes to an image of a local map which includes highlights of various local venues, and/or people and/or merchants and/or any other items that fall within the default filters, the filters that the user has selected or selects. As with most mapping apps, the map may be scrollable and/or otherwise movable and/or otherwise zoomed. Additionally, the user may select a map based on a city/state or based on a zip code etc. The user may be provided the option to select an area on the displayed map (either using predetermined shape tools or with a free form hand drawing). When the user selects a bounded area, the map highlights points of interest within that bounded area. Additionally, in the event that the hand drawn boundary is not closed, the application will finish closing off the area.

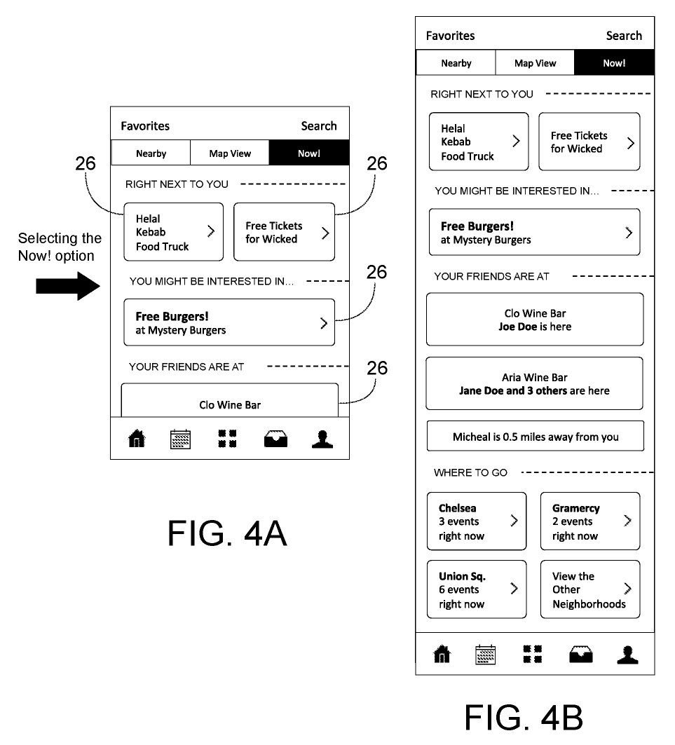

If the user selects the “Now” option 24 from the dashboard, the display changes to that of FIG. 4a. As illustrated, the Now display provides the user with information about current events 26 such as local food trucks, local offers or promotions, local merchant specials, locations and/or events of potential interest, location of friends etc. While not required, the amount of information may not fit onto a single screen. The user may be provided the option to scroll for additional information (FIG. 4b), or swipe the image for additional information (not illustrated) or click on an icon for additional information (also not illustrated). Additionally, the user may click on any of the topics to receive additional information and/or options related to the selected topic.

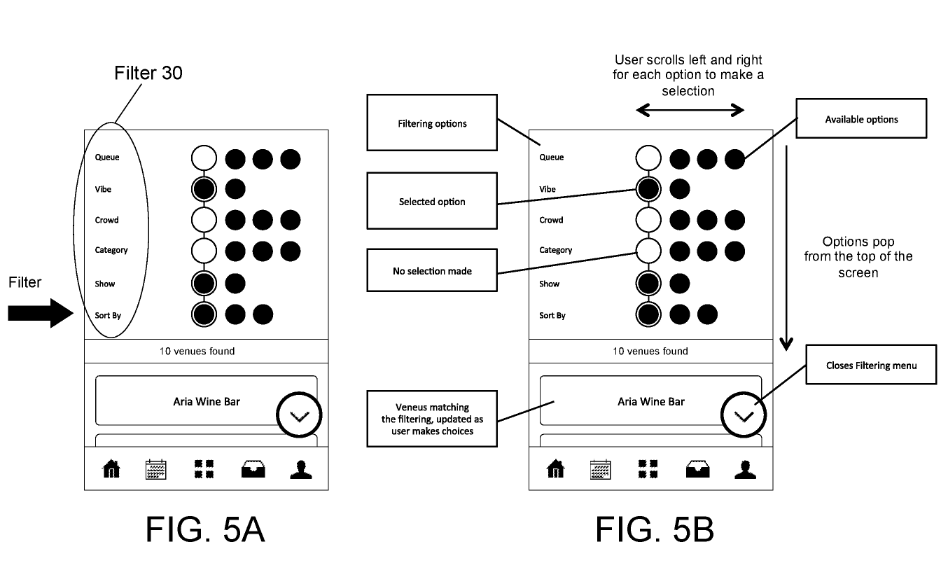

FIGS. 5a-b illustrate that the user may filter 30 the information that is provided. For example, the user can filter for locations with short wait times (queues), a lively atmosphere, offbeat places, crowded places (e.g., sports bars), lightly crowded places (e.g., restaurants), celebrity spotted, ratings, etc. Those skilled in the art will recognize that the filters and the selections within each filter are design choices and can include additional filters or fewer filters. Further, the filters can be global filters that are applied to all locations, can be grouped filters (e.g., apply to all restaurants, apply to all Italian restaurants, apply to all bars/pubs, apply to all theaters, etc.) or can be applied to selected locations (e.g., apply to a particular wine bar). While the figures illustrate the filter options as circles, those skilled in the art will recognize that radio boxes, check boxes, slide bars, or any other conventional type of selection device may be employed without departing from a scope of one or more of the claims.

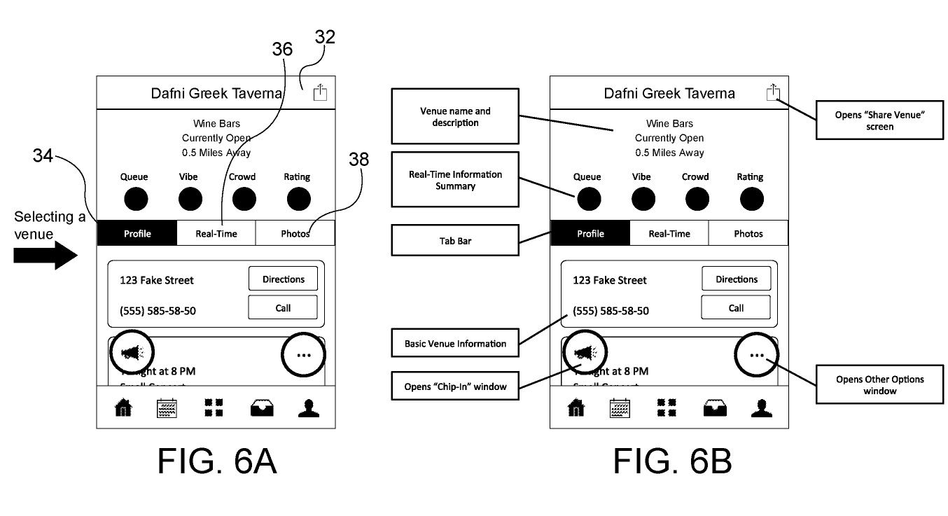

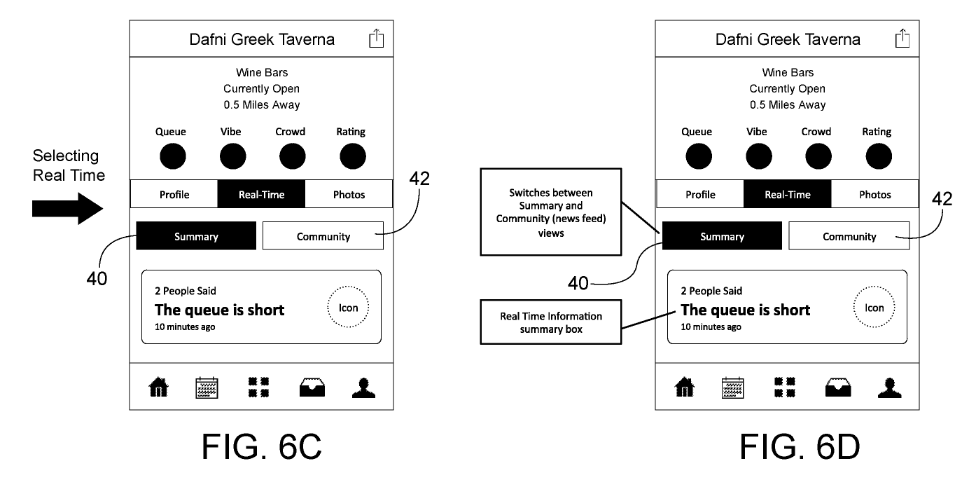

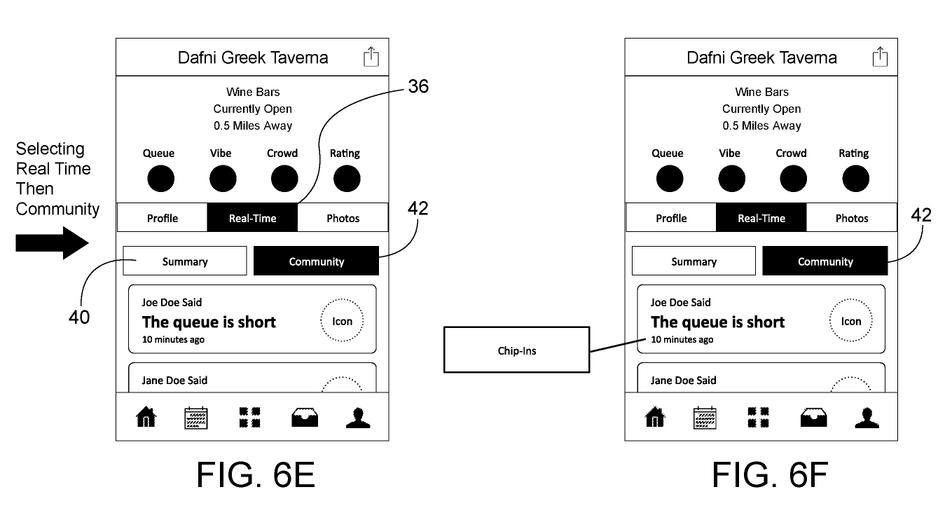

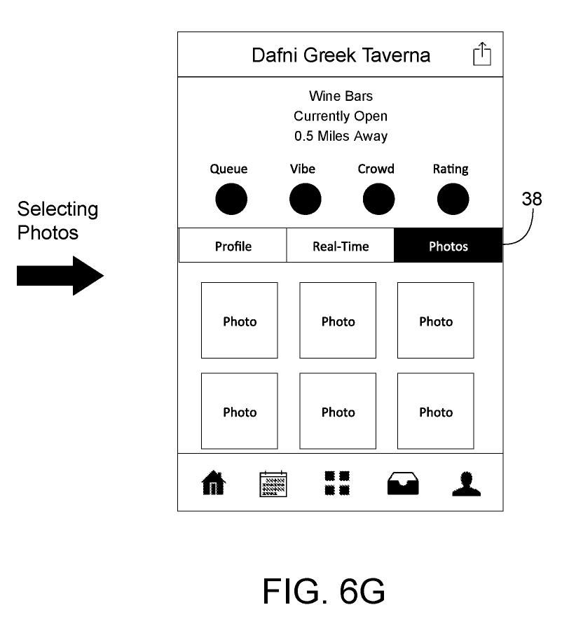

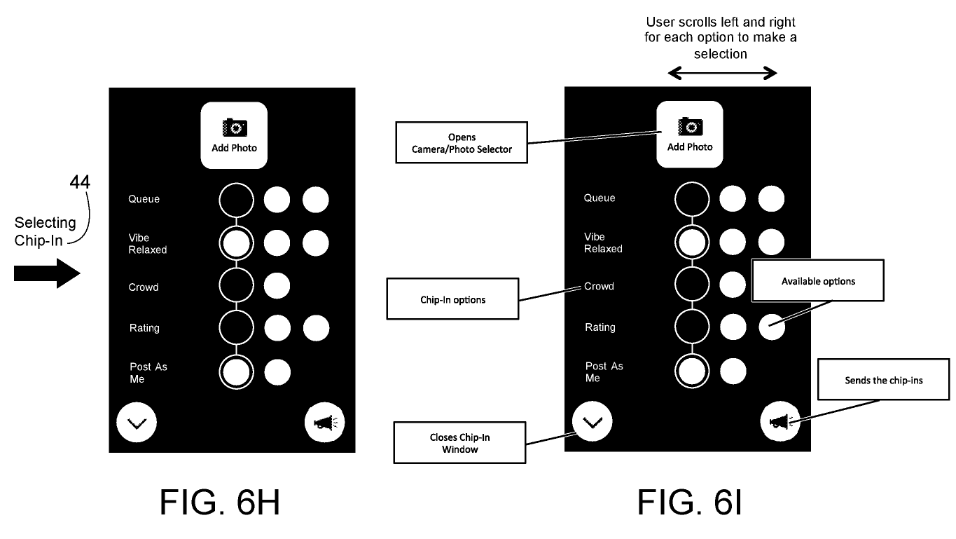

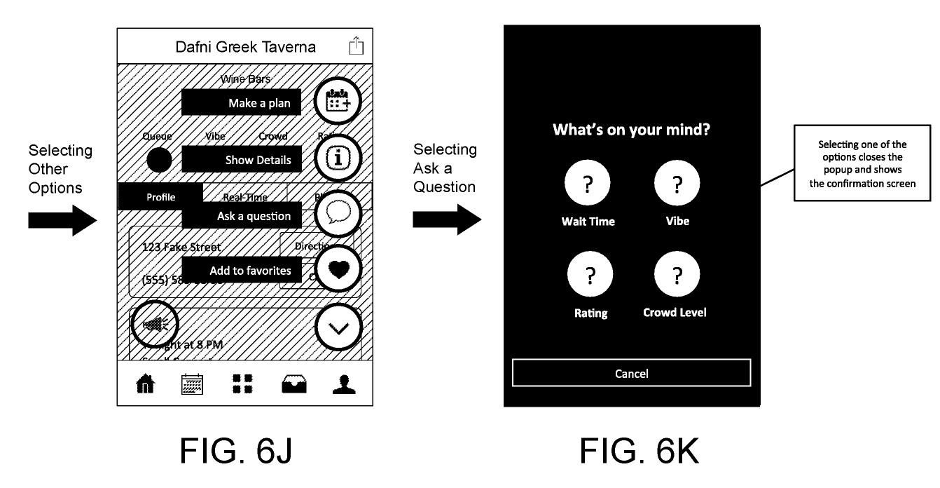

When a user selects a particular venue 32, a Venue display is provided (FIGS. 6a-k) which displays the type of venue, and the selected information which conforms to the selected filters. In FIG. 6a, the particular venue is Dafni Greek Tavern, which is a wine bar, that is currently open and which is 0.5 miles from the mobile device. The address and contact information is provided, as options to determine the estimated waiting time or the number of people in line (e.g., number of people waiting, estimated wait time, etc.), the atmosphere, the relative size of the crowd, and the rating for the venue. The default display is the Profile page 34 for the venue and the user is provided the option to select real time information and/or photographs 38 of the venue (and/or, if available, video of the venue). The photos or videos 38 may present the current or past status of the venue. Past status based on aforementioned type of crowdsourced information typically has a Time To Live (TTL) that varies from one category of venues to another depending on the length of time the information regarding the status of venue category remains relevant to the user. Those skilled in the art will recognize that the default setting is a design choice and other default displays may be employed. If the user selects Real Time 36 (FIGS. 6c-f) then the display defaults to a real time summary 40 of information for the venue. As illustrated in FIG. 6c, this information may include recent information received from actual attendees at the venue, the time when the information was provided and how many people provided the same or similar information. The user is also provided with a Community option 42 which separates the information by specific user (FIGS. 6e-f). If the user selects Photos 38 (FIG. 6g) then, as stated above, the user is provided with photos of the venue. The photos may include all photos or video clips of the venue, it may provide only photos or video clips within a certain amount of time from the current time (e.g., all photos within the past hour, ½ hour, 2 hours, etc.), it may include venue provided photos or video clips (e.g., by a merchant or its supplier) and/or it may provide user provided photos or video clips. The user may be provided with the option to filter which type of photos or video clips to view. In FIGS. 6h-i, the user is provided the ability to add their own information about the venue (e.g., photos, queue status, crowd status, etc.) also referred to herein as a Chip-in 44 of any type of ephemeral information that better informs others about the current status of the venue at the present time or certain day/time of the week (e.g., Friday night status) using the stored ephemeral data. For photos, the user is afforded the ability to access the mobile device camera through the app and may be provided with the ability to access photos stored on the mobile device (although such access may be restricted in an effort to ensure that only relevant photos are uploaded to the venue). Additionally, there may be a delay in uploading photographs and other information in an effort to prevent inappropriate information and photos from being shared. Some additional options available to the user (FIGS. 6j-k) include inviting people to meet at the venue, making a reservation for the venue, adding a name to the queue list for the venue, displaying additional information about the venue (e.g., menu, shows, show times, etc.), ask a question of the venue and/or of attendees at the venue and add the venue to a list of favorites or a particular collection.

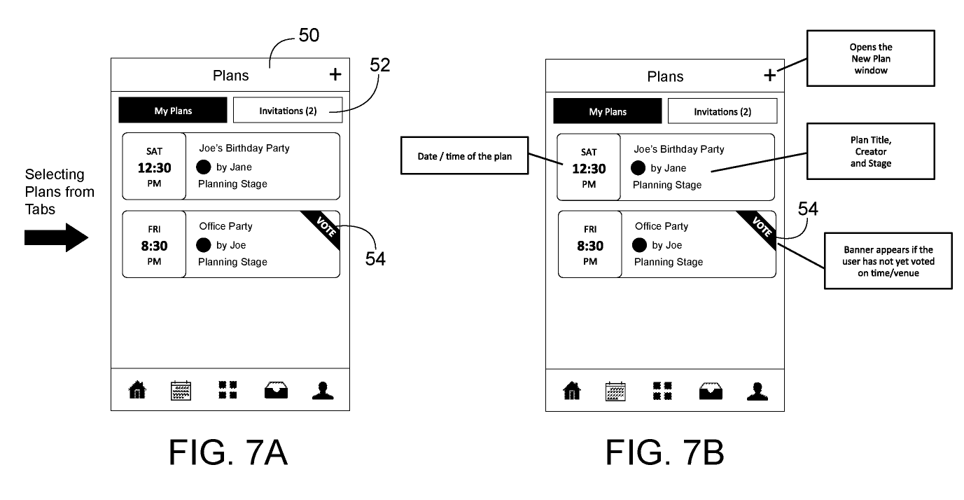

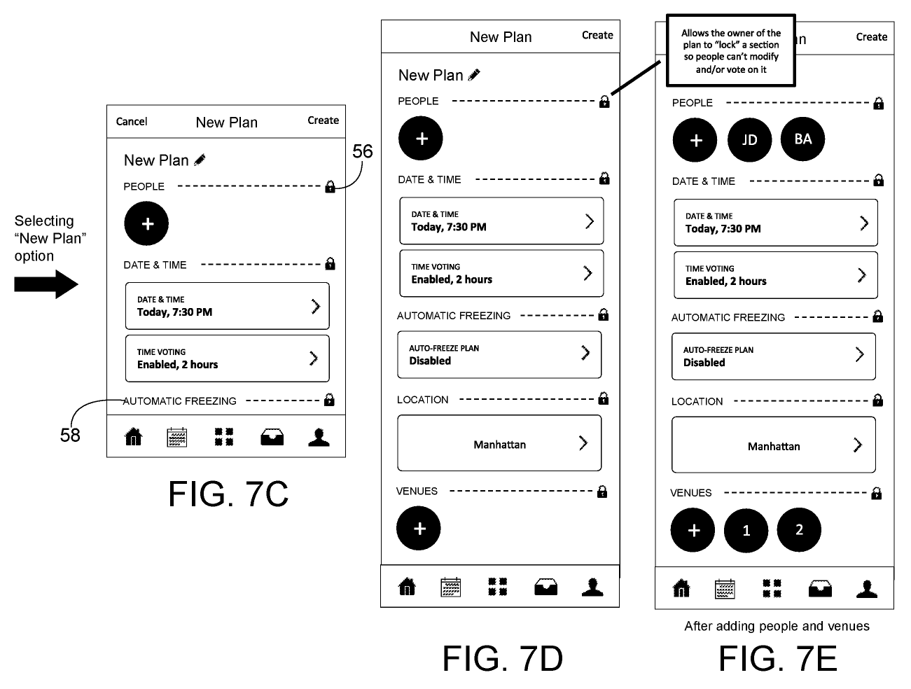

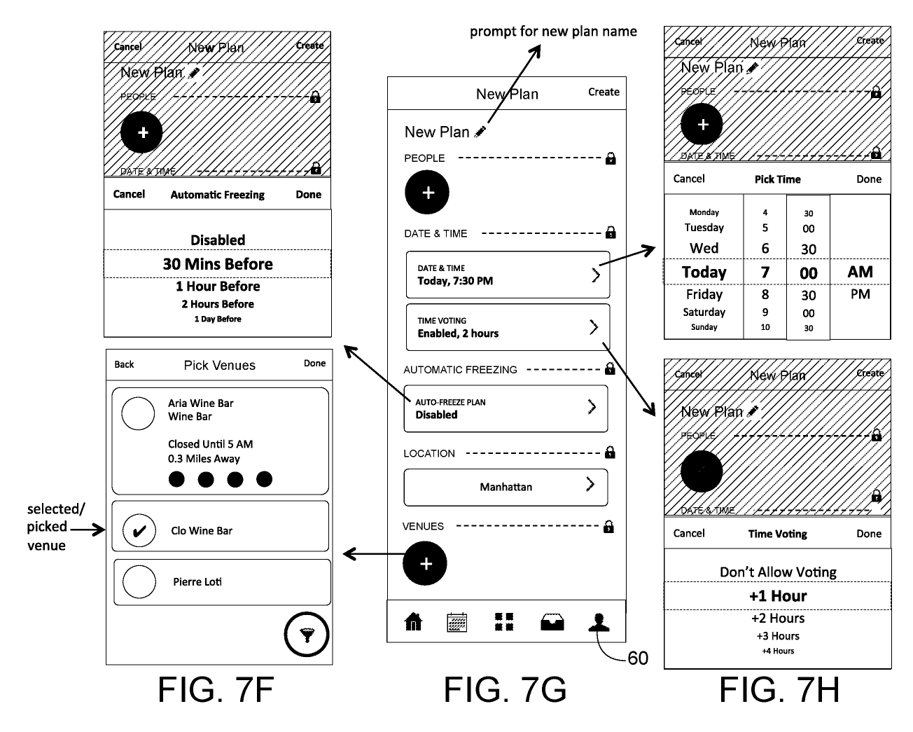

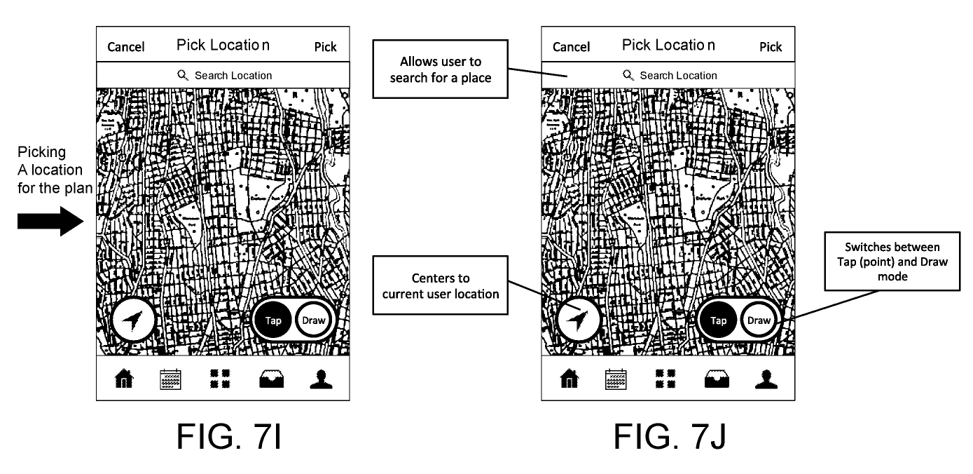

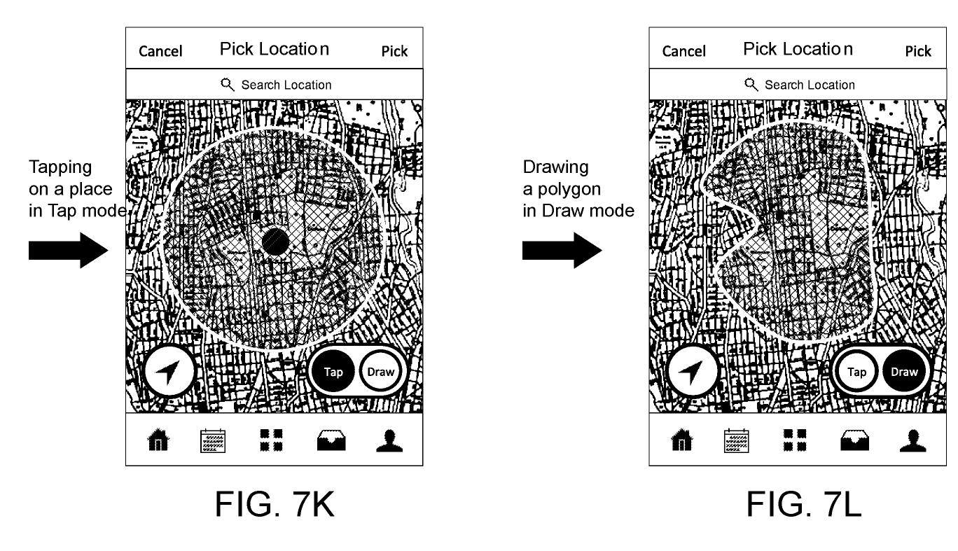

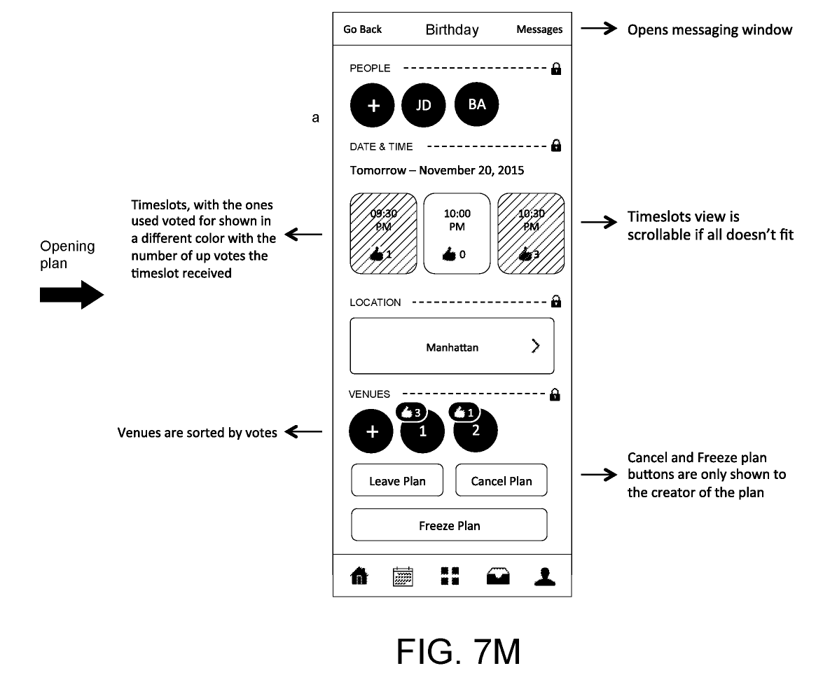

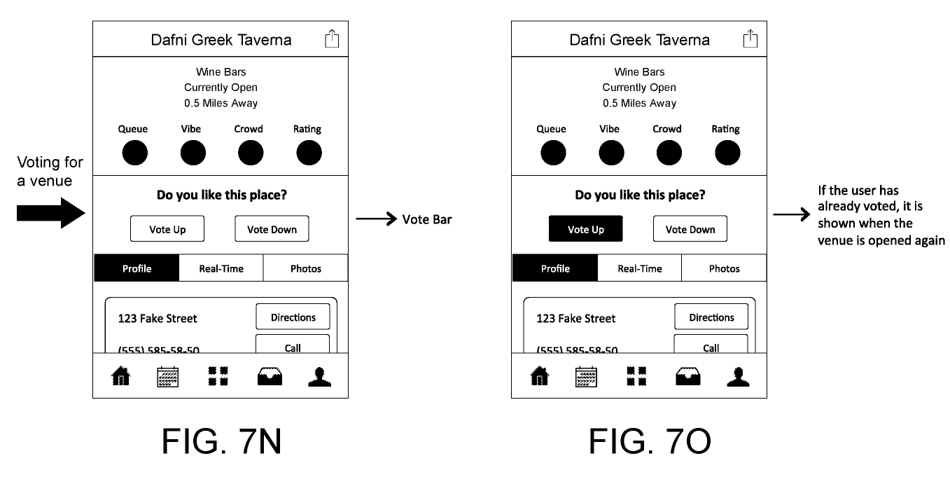

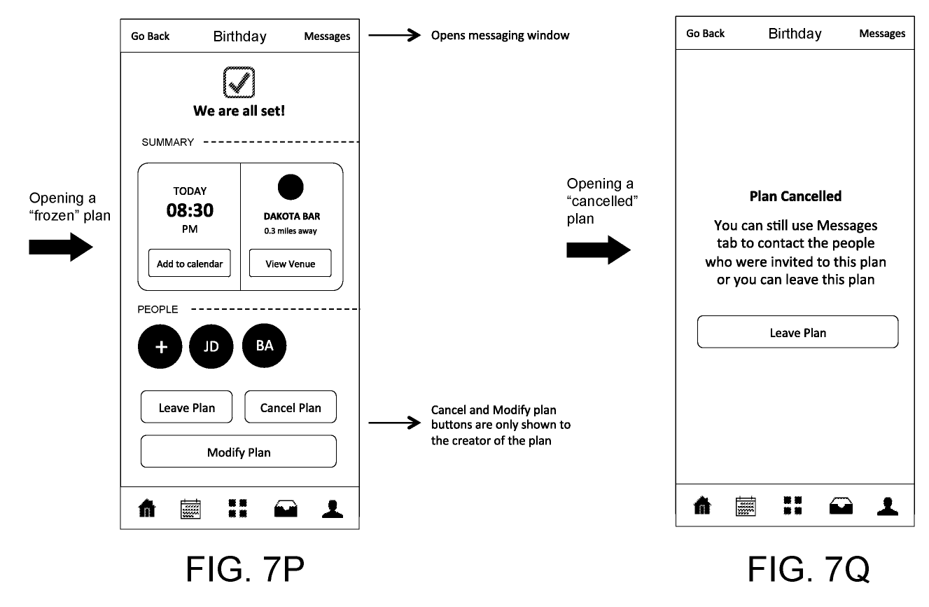

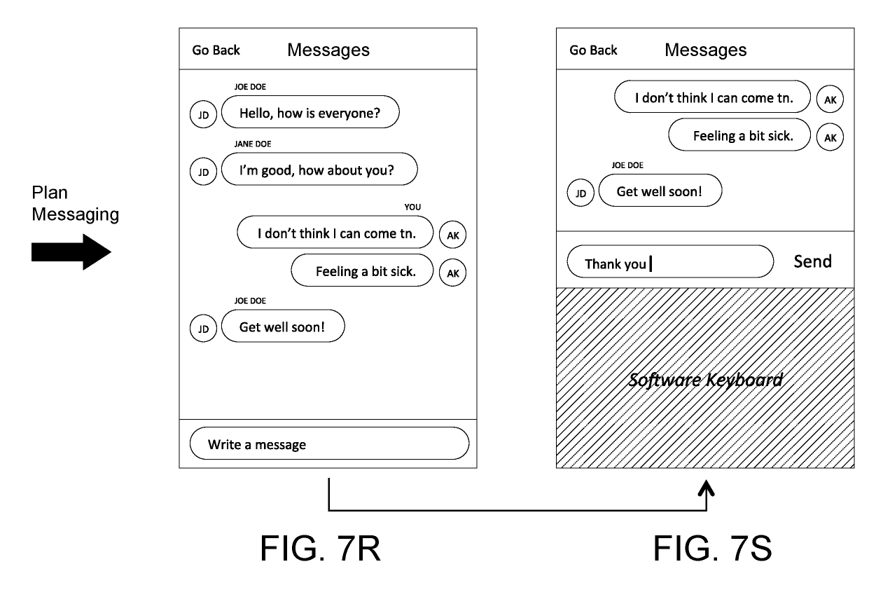

FIGS. 7a-s illustrate the Plan feature 50. This feature allows users to create meetings, parties, events, etc. and invite people 52 to attend and/or vote 54 on the various aspects of the plan. For each aspect of the plan, the creator may leave the aspect unlocked, in which case invitees may edit the aspect (e.g., add other invitees, suggest another date, another time, another neighborhood, other venues, etc.) or they may lock 56 a particular section thus preventing modifications from invitees. In addition, the plan may provide voting rights/options to the invitees. If the aspect is unlocked and the creator or an invitee has provided various options to vote on, then the invitee may select one of the options to vote on or may be provided the option to add an additional option on which to vote (e.g., the creator of the plan may provide a choice of two or more venues from which to choose and the invitees are requested to select one of the venues and/or propose another venue). The voting may continue until the planner stops the voting, until a certain threshold consensus is reached/exceeded or it may have a time limit associated with the voting. Another option that is provided to the planner is an automatic or manual Freeze 58. The auto-freeze enables the plan creator to set a limit on all aspects of the plan (e.g., ½ hour before the event, 1 hour before the event, 2 hours before the event, etc.). This auto-freeze feature essentially closes the plan at the designated time. Alternatively, the plan creator may manually freeze a plan at which time the final details are provided to all those who are associated with the plan at the time the plan is frozen.

Another option for the plan creator and the invitees is a messaging feature 60. Any person associated with the plan may communicate with any other person or group using an instant messaging feature. While not illustrated, the parties associated with the plan may also or alternatively be provided the option for video and/or voice communications with one or more other parties/groups. At any time, the creator of the plan may cancel, modify or delegate the plan. In the event that a plan is cancelled, the messaging feature may still be available to invitees. As far as the venue, the planner may select an area on a map and propose one or more venues from within the same area 7I, 7J, may select from a list of venues in a collection, or select one or more venues from different areas. As with the mapping function discussed above, the selection of an area on the map may employ city/state, zip codes, predefined shapes 7K or free form shapes 7L.

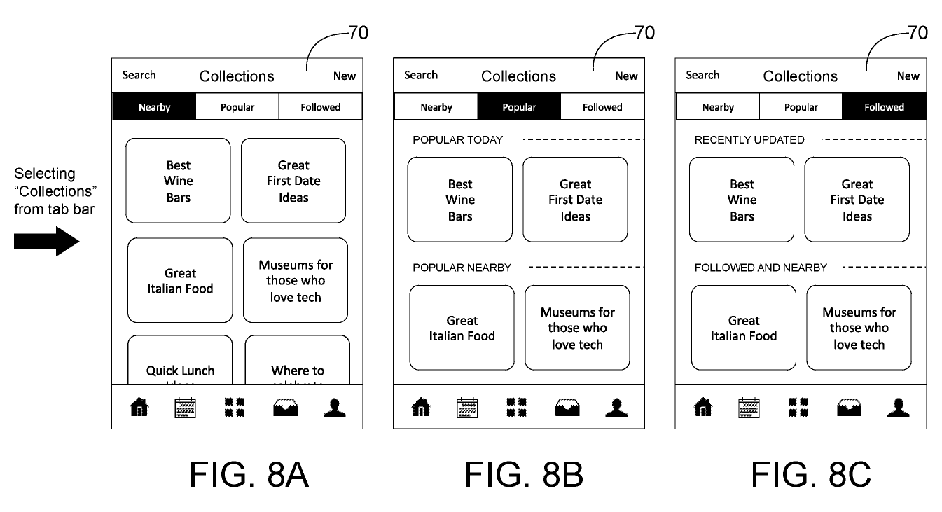

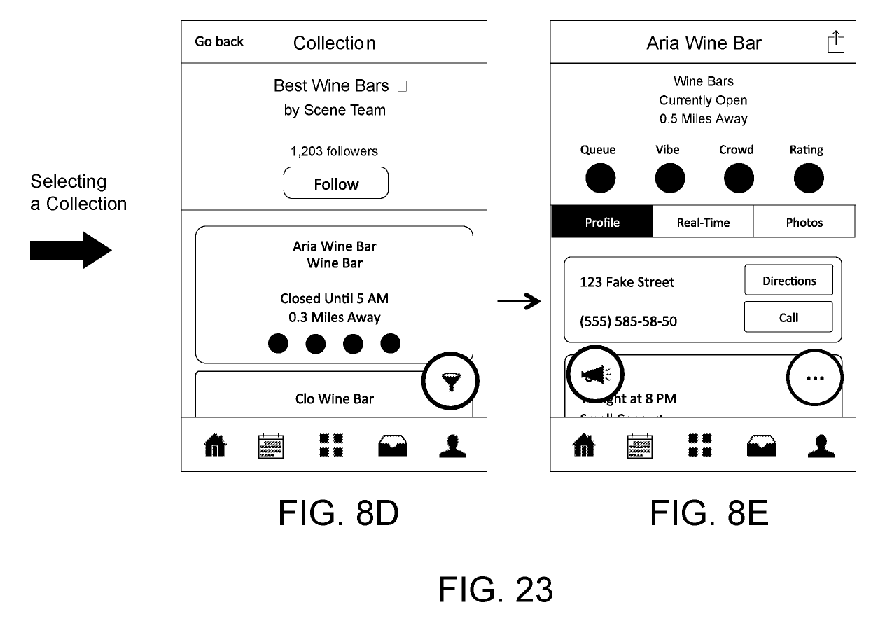

As illustrated in FIGS. 8a-c, a user may be provided with the option to create collections, view other people's collections 70, follow other people's collection(s), adopt/download other people's collection(s) and share collections. A collection 70 may be a “top 10” list (e.g., hot spots in West Hollywood, etc.), may be as simple as a list of common items (e.g., favorite Italian restaurants in NYC, etc.), may be a worst of list, may be limited by proximity to the current location of the mobile device, may be limited to a popular consensus (e.g., items that the most people, or at least a certain number of people include in a particular collection), may be limited to time and date of the week tied to certain type of event or activity (e.g., weekend author events at book stores in Austin, etc.) or may be limited by ephemeral data that is changing (e.g., clubs with shortest queue), etc.

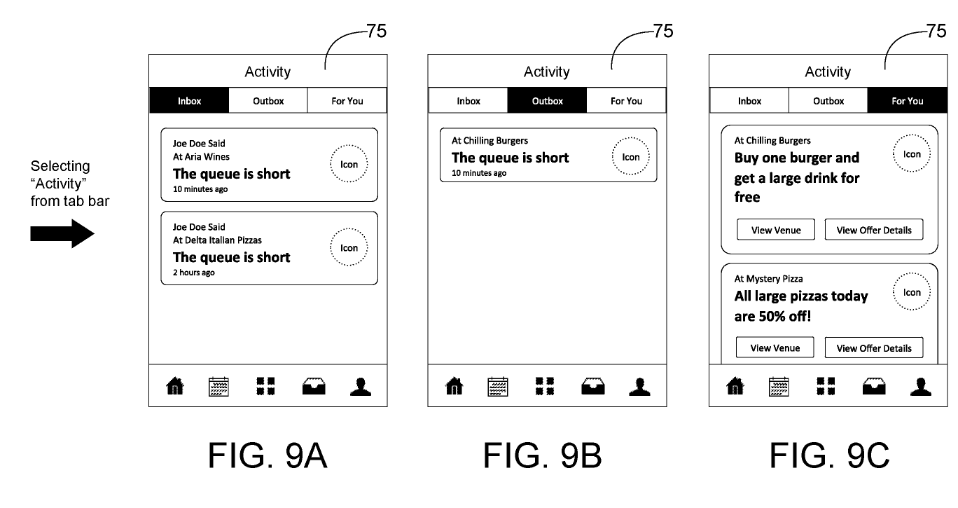

Another feature that is available to the user is the Activity feature 75. This feature, which is illustrated in FIGS. 9a-c provides a list of Chip-ins 44 provided by friends, a list of chip-ins that the user of the mobile device provided to other people and a list local advertisements/offers. These activities 75 may be limited by time, proximity or they may remain in the activity folders until removed by the user or automatically removed if scheduled before a specified date.

Having generally described the various features, the following will provide a more detailed description of how the features are implemented.

Discovery—the platform allows for different types of signals from fixed or mobile communication devices (e.g., Bluetooth Low Energy (BLE), WiFi, ProSe or LTE-D) to be registered independently or with the help of a mobile application. Once the devices are registered they can be enabled for the discovery service by the platform's backend or a local edge server (e.g., a scaled down version of the backend with less functionality installed in a venue) to advertise a platform specific message, a promotion (e.g., food cart vendor offering lunch special) or a rich media advertisement (e.g., a cosmetic product promotion broadcasted as a video ad to mobile devices in the proximity of cosmetic department), which will allow for multimodal discovery with at least one of the different types of beacons capable of triggering a simple message and/or more complex content to be delivered to a nearby device.

Real time reporting—as applications discover devices registered on the platform they can use a real time reporting service with categories configured for each discoverable device. An example can be a BLE beacon advertising a signal, to fixed or mobile entities. Upon the smartphone app discovering the signal a real time report may be triggered, with or without user interaction with the smartphone, providing for either i) ephemeral data, such as the queue time or ii) non-ephemeral data, such as the existence or non-existence of the venue (e.g., a food cart not present at the usual location) in the case of a BLE beacon signal not being detected.

Planning/Event Coordination—a methodology is provided for coordinating a group activity with or without real time data and proximity based content. The platform presents users with information filtered on the reported data by other users (e.g., crowdsourced information), which may be used by the users to create a plan (e.g., planning a get together at a moderately crowded sports bar to watch a football game, etc.). An event plan can be advertised and discovered either on a proximal or non-proximal basis as any other piece of information from the platform. For example, the proximal discovery of an event could be facilitated by the Platform's broadcast of the event information via a ProSe or LTE-D beacon (e.g., organizing a pick-up game at the park with nearby basketball players). FIGS. 7a-s and the associated texts describe the details of a non-proximal type of event planning.

e-Commerce—available goods or services, as well as any promotions, may be offered through the consumer application as a result of i) offers or promotion published through the merchant app in the backend or ii) in a proximal fashion through broadcast of a beacon from fixed or mobile devices. In this later case of proximal discovery, the Discovery Services provides the platform users the opportunity to receive real time data on the availability of products (e.g., perishable food items advertised to passersby, etc.) and/or services (e.g., a highly rated plumber available in the neighborhood, a hair salon having seats available at a discount, etc.). The platform also allows applications and devices to register a) offers and promotions from merchants or service providers or b) products or services desired by users. In both cases detailed descriptions of products and services may be included which will be discoverable by nearby users/devices/applications connected to the platform. With the combination of the consumer and merchant apps, this platform provides for a real time clearinghouse of both real and virtual (e.g., queue position) products and services, which in certain cases, are assisted by proximal and/or ephemeral data.

Dynamic Pricing—the platform may include dynamic pricing algorithms which balance proximal offer/demand for goods/services offered. For example, a food truck vendor at a park can broadcast prices, which are tied to the number of the interested users in a digital queue within a certain proximity of the food truck (e.g., the prices could rise if there appears to be great demand for the food and could drop if the demand is minimal). In this case user interest in the food could be based on the user specified list of items of interest in the app, past behavior as determined by the platform's analytics engine, or LTE-D filters downloaded in the mobile device that specify an interest in food.

Payments—users may be provided the option to pay for goods/services that are registered on the platform through various conventional card present or card-not-present (i.e., card on file) payment methods supported by the platform.

Search—the platform allows devices and applications to access search capabilities for services/places/objects/users in proximity. Aggregated searches and parameters may be converted into collections by the platform.

Machine Learning Services—using the data generated by the applications and devices, the platform employs conventional learning tools to provide users/applications with recommendations.

Wallpaper—from the Loyalty button in the app “Preferences/Settings” menu of the consumer app, users are provided the option to display rich, animated and interactive backgrounds with pictures and information that are provided by the platform on their home screen as their Live Wallpaper. These backgrounds may be a photo or an animation supplied by a merchant, a brand advertiser (e.g., Gap jeans that may be in certain nearby boutiques), a public place (e.g., museums, churches or historic place), object (e.g., car charging station or vending machine) or a person (e.g., tour guide or tutor in library, etc.) within a certain proximity of the mobile device (“Proximal Wallpaper”).

The defined area for Proximal Wallpaper photo apps may be established by either proximity to a) beacons (iBeacon, Eddystone beacon, WiFi beacon or a ProSe/LTE-D broadcasted message) and/or b) as specified by the user in the app preferences (e.g., 300 meters or 500 meters of all or some of the advertising merchants or desired venues) which will be managed by the backend system when a user is within the proximity of the participating merchants, that are selected in the app's settings (e.g., in favorites or as a group of objects such as all vending machines), regardless of a beacon being in the vicinity or not.

Users can set how Proximal Wallpaper is rotated among all advertisers (e.g., every 5 minutes, 10 minutes, 30 minutes or hourly), for a period of time (e.g., next 24 hours) or at certain frequency for just certain advertisers (e.g., every two hours for 15 minutes or every day at noon for one hour). The content of Live Wallpapers could be a) uploaded by the merchants on a real time basis, b) pre-loaded in the merchant database in the backend or c) Live Wallpaper chip-in by various users (this item is also a user selectable feature since it is not necessarily advertising and it may result in a real time event alert with rich content).

The backend system may offer Proximal Wallpaper as a) merchant ads for those merchants who are subscribing to payment services/loyalty programs (based on a monthly subscription fee) or elect to advertise their offers through Proximal Wallpaper from time to time for a per ad fee (as opposed to limiting their offers to be displayed only on merchant pages that are free of charge), b) brand advertising (e.g., Gap jeans, Nike, etc.), advertising by public venues (e.g., museum specials, exhibitions, churches), advertising of objects (e.g., car charging stations, vending machines, parking spot) or c) real time chip-ins 44 from those in the favorites or otherwise allowed by the user including merchants, brand merchandisers, locations or objects if permitted by the user.

Clicking in a designated advertisement area of the Live Wallpaper may act as a link to a page inside the app that shows the offer details. This additional feature can optionally be turned on or off by the user in the app's settings.

As an incentive for users to select this feature, users may be provided with points or some other reward for each of the ads displayed as a Proximal Live Wallpaper. Those points can be accumulated and redeemed for gifts/prizes which may include vouchers for making purchases from merchants, they may include instant rewards, etc. Additional rewards (additional points, instant prizes, etc.) may also be awarded if users make a purchase while in the area where a Proximal Live Wallpaper ad is being displayed. In one or more embodiments the user may receive a service credit for their monthly subscription fees for using this feature.

For the big data analytics and transaction histories, interactions between Places, People and Objects are encapsulated in a unit called EDICT (which stands for Explore, Discover, Inform, Communicate, Transact). An EDICT can represent any type of transaction (e.g., purchase of a product or service, publicly shared or rental vehicle discovery and pick-up, planned birthday party, scheduling an appointment, etc.), which may incorporate certain contextual and/or ephemeral metadata or disjoint data (“Transaction”) further enhancing the extent of information captured for any transaction. At a user's (i.e., consumer's or merchant's) election, certain EDICTs resulting in a transfer of ownership or rental of an item representing a certain value to the users can be protected by a blockchain. The ownership registration through the blockchain can facilitate proximal sale of any product that may require a title transfer or rental agreement.

Each EDICT, especially those incorporating a chip-in, can also be treated as the equivalent of a time capsule for any event. Users who want to store those types of events (e.g., event snapshots) can elect to subscribe to the cloud services for long term storage of the EDICTs (e.g., discovery and interactions related to an exhibition booth, wedding vows, high valued gift delivery record, etc.) with or without chip-ins or blockchain registration.

An EDICT may provide a detailed description, along with a part of the history, of a proximal Transaction more so than what metadata does for content. For example, a car key incorporating an Internet of Things (IoT) (e.g., 3GPP Cat-0 or Cat-M1 modem) chip with an embedded blockchain may be employed for spot rentals of cars, or permission-based pick-up of shared cars, supported by consumer app search and discovery (e.g., via a beacon or broadcast of an LTE-D private expression) functions and through various rule-based manners that can change dynamically (e.g., according to location, time-of-day, model of the car, etc.). This concept may be extended to self-driving cars or publicly owned cars to boot without a key through the mobile device with the app performing discovery and communications with the desired car while receiving authorization by running a blockchain light client module (e.g., Ethereum). Such vehicles might receive some of the digital money exchanged for rent to pay for fuel, repairs and parking spaces, all according to preprogrammed rules.

The platform may also support distributed smart devices (e.g., IoT Cat-0 or Cat-M1 modem) with embedded blockchain to become independent agents, autonomously conducting a variety of transactions. For example, a vending machine not only can be discovered but also can monitor and report its own stock, solicit bids from distributors and pay for the delivery of new items automatically—based on the purchase history of its customers. In cases where a smart device does not contain an embedded blockchain, the platform can manage the association between a network of smart devices with multi-hop capability (i.e., packet routing) where a smart device without an embedded blockchain can connect, through a wired or wireless connection, to any device running the consumer or merchant app with embedded blockchain for completing a transaction.

FIG. 10 very generally illustrates a system for employing the platform technology which includes backend servers in the cloud or network's edge where the edge server is an intermediate node anywhere between the device and the cloud. The cloud server or the edge server may communicate with the mobile device and the beacon, for programming of the broadcast message, via a network (e.g., the Internet), a direct wired connection, a wireless connection, a satellite connection or via any other conventional communication path. The communication path between the mobile device and the server and/or the communication path between the beacon and the server may be a secure path or an unsecure path depending upon the design choice of the system and/or the requirements of a particular operation. For example, a payment may be performed over a secure path whereas a search for ephemeral data may be communicated via an unsecure path. While the description has been limited to a single mobile device, a single beacon and one or more servers, the platform's network of devices and servers is typically not so limited. Those skilled in the art will recognize that multiple mobile devices (the same or different types), and/or multiple beacons (the same or different types) and/or multiple servers may be employed within the system and still fall within a spirit and scope of one or more claims which define the protection for this technology. The description is limited to a single mobile device, a single beacon and a single server for ease of explanation only and thus is not to be considered a limitation on the technology.

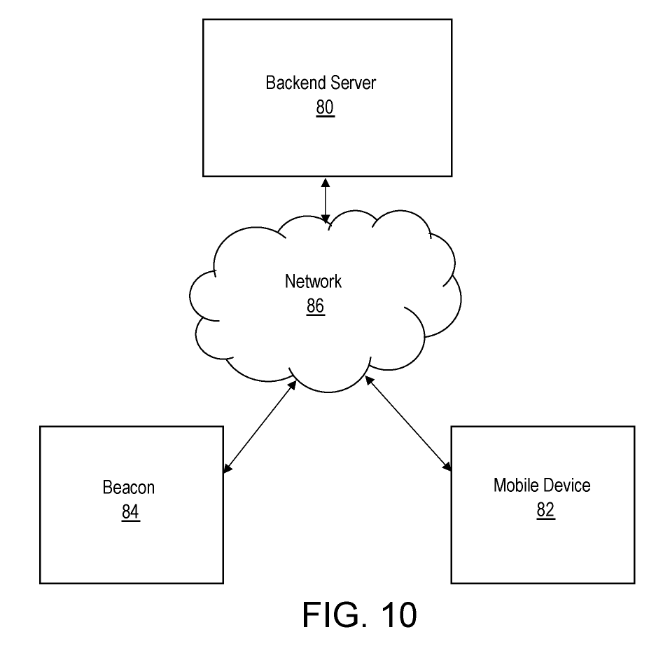

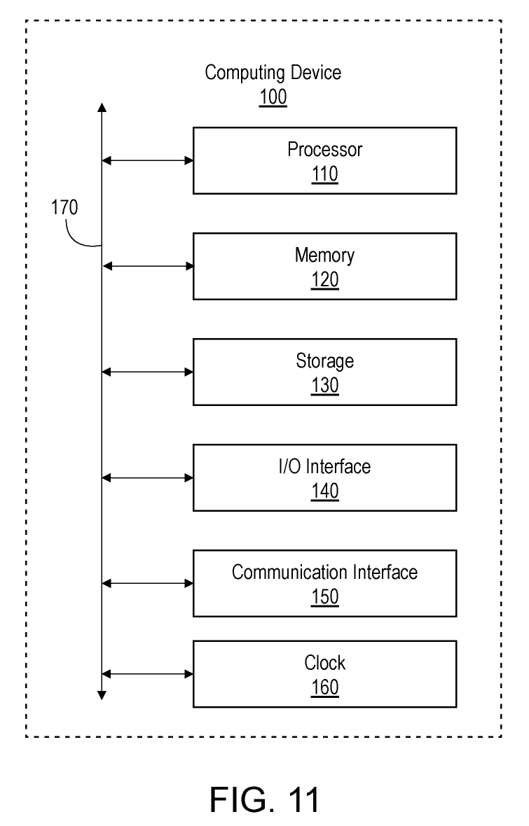

FIG. 11 very generally illustrates elements that will be present in each of the devices 100 (mobile, beacon and server). These are conventional elements and thus their operation and interconnections will not be further discussed herein. Those skilled in the art are deemed to understand how elements such as processor 110, memory 120, storage 130, input/output (“I/O”) interface 140, communications interface 150 and clock 160 send and/or receive messages via bus 170. While these elements are not illustrated in the block diagram of FIG. 10, those skilled in the art will recognize that mobile device, beacon and server each includes, among others, these elements and that the interaction between 2 or more of these elements is required to perform the functions of the disclosed technology.

Having thus described preferred embodiments of the technology, advantages can be appreciated. Variations from the described embodiments exist without departing from the scope of the technology. Thus it is seen that systems and methods are provided for an integrated platform for discovery, messaging, integrated social networking and electronic commerce, including Payments. Although particular embodiments have been disclosed herein in detail, this has been done for purposes of illustration only, and is not intended to be limiting with respect to the scope of the claims, which follow. In particular, it is contemplated by the inventors that various substitutions, alterations, and modifications may be made without departing from the spirit and scope of the technology as defined by the claims. Other aspects, advantages, and modifications are considered to be within the scope of the following claims. The claims presented are representative of the technology disclosed herein. Other, unclaimed technology is also contemplated. The inventors reserve the right to pursue protection for such technology in later claims.

Insofar as embodiments of the technology described above are implemented, at least in part, using a computer system, it will be appreciated that a computer program for implementing at least part of the described methods and/or the described systems is envisaged as an aspect of the invention. The computer system may be any suitable apparatus, system or device, electronic, optical, or a combination thereof. For example, the computer system may be a programmable data processing apparatus, a computer, a Digital Signal Processor, an optical computer or a microprocessor. The computer program may be embodied as source code and undergo compilation for implementation on a computer, or may be embodied as object code, as another example.

It is also conceivable that some or all of the functionality ascribed to the computer program or computer system aforementioned may be implemented in hardware, for example by one or more application specific integrated circuits and/or optical elements. Suitably, the computer program can be stored on a carrier medium in computer usable form, which is also envisaged as an aspect of the invention. For example, the carrier medium may be solid-state memory, optical or magneto-optical memory such as a readable and/or writable disk for example a compact disk (CD) or a digital versatile disk (DVD), or magnetic memory such as disk or tape, and the computer system can utilize the program to configure it for operation. The computer program may also be supplied from a remote source embodied in a carrier medium such as an electronic signal, including a radio frequency carrier wave or an optical carrier wave.

It is accordingly intended that all matter contained in the above description or shown in the accompanying drawings be interpreted as illustrative rather than in a limiting sense. It is also to be understood that the following claims are intended to cover all of the generic and specific features of the technology as described herein, and all statements of the scope of the technology which, as a matter of language, might be said to fall there between.

Having described the invention, what is claimed as new and secured by Letters Patent is:

1. A system for discovery, messaging, bookings, reservations, integrated social network and e-commerce, including Payments, the system comprising:
at least one backend server and at least one mobile device;
the mobile device being in selective electrical communication with the backend server;
a graphical user interface (GUI) associated with the mobile device;
said GUI providing a plurality of features to a user of the mobile device; wherein
at least one of the features is selected from the group of features including discovery, messaging, bookings, reservations, social networking and e-commerce, including Payments;
at least one beacon transmitting a signal for receipt by said mobile device;
wherein at least one of said features is capable of being bounded by an area proximal to said at least one beacon.

2. The system according to claim 1 wherein said social networking feature includes at least two features selected from the list of features consisting of a collections feature, a mapping feature, a Now feature, a Nearby feature, a venue selection feature, a venue information feature, a communication feature, a planning feature, and an activity feature.

3. The system according to claim 1 wherein said e-commerce feature includes at least two features selected from the list of features consisting of targeted advertising, blockchain transactions, bookings, reservations, dynamic pricing, analytics, loyalty programs, and mobile payment.

4. The system according to claim 1 wherein at least one interaction involving social networking is encapsulated in a unit of information.

5. The system according to claim 1 wherein at least one interaction involving e-commerce is encapsulated in a unit of information.

6. The system according to claim 1 further including a plurality of smart devices configured to autonomously conduct at least one transaction with said mobile device.

7. The system according to claim 1 further including a blockchain; wherein said blockchain includes metadata associated with a transaction related to at least one of the plurality of features.

8. A method for providing an integrated platform solution delivering localized discovery, messaging, bookings, reservations, social network and e-commerce, including Payments, on a mobile device through an application running on the mobile device, wherein the mobile device is capable of detecting a signal from at least one beacon, the method comprising:
the mobile device detecting the signal from the beacon;
the mobile device receiving as input a selection of a feature related to said signal from said beacon;
said mobile device sending a query to a backend server for information related to said feature;
said mobile device receiving a response to said query and displaying the response to the query on a display associated with the mobile device.

9. The method according to claim 8 wherein said feature is at least one feature selected from the group of features consisting of a collections feature, a mapping feature, a Now feature, a Nearby feature, a venue selection feature, a venue information feature, a communication feature, a planning feature, and an activity feature.

10. The method according to claim 9 further including encapsulating in a unit of information at least one interaction involving said communication feature.

11. The method according to claim 8 wherein said feature is at least one feature selected from the group of features consisting of bookings, reservations, dynamic pricing, targeted advertising, blockchain transactions, analytics, loyalty programs, and mobile payment.

12. The method according to claim 8 further including encapsulating in a unit of information at least one interaction involving social networking.

13. The method according to claim 8 further including encapsulating in a unit of information at least one interaction involving e-commerce.

14. The method according to claim 8 further including encapsulating in a unit of information at least one interaction involving discovery.

15. The method according to claim 8 further including encapsulating in a unit of information at least one interaction involving messaging.

16. The method according to claim 8 further including encapsulating in a unit of information at least one interaction involving an appointment or booking.

17. The method according to claim 8 further including encapsulating in a unit of information at least one interaction involving a reservation.

18. The method according to claim 8 further including displaying proximal wallpaper on the display,

19. The method according to claim 18 wherein said proximal wallpaper includes at least one advertisement.

20. The method according to claim 18 further including providing an incentive for a user to allow proximal wallpaper to be displayed on the mobile device.

21. A method for providing a localized integrated discovery, messaging, bookings, reservations, social network and e-commerce, including Payments, platform on a mobile device through an application running on the mobile device, wherein the mobile device is configured to detect a signal from at least one beacon, the method comprising:
the beacon transmitting a signal for receipt by a mobile device located proximal to said beacon;
the beacon receiving data from a server for programming the beacon to transmit a message in the signal about a venue associated with the beacon;
wherein the message is updated in real time or substantially real time to provide current information about the venue.

22. The method according to claim 21 wherein said message includes at least one bit of information selected from the list of information including an object, a crowd size, a list of attendees, a queue size, a wait time, a photograph, a video, an inventory, and a physical location of the object, the event, or the venue.

23. The method according to claim 21 wherein said data includes at least one bit of information selected from the list of information consisting of a booking, a reservation record, a dynamic pricing record, a transaction record, a targeted advertisement record, a blockchain transaction, a contract record, an ownership record, an analytics record, a loyalty program record, and a payment record.
